(19) United States
(12) Patent Application Publication
(10) Pub. No.: US 2003/0204416 A1
(43) Pub. Date: Oct. 30, 2003

(54) System and method for facilitating time-based infusion orders

(76) Inventors: Sayeh Radpay, Toronto (CA); Meetali Acharya, Burlington (CA); Eric S. Paul, North York (CA); Kaivan Talachian, Richmond Hill (CA)

Correspondence Address: Francis C. Kowalik, Esq., Corporate Counsel, Law Department, BAXTER INTERNATIONAL INC., One Baxter Parkway, DF3-2E, Deerfield, IL, 60015, US

(21) Appl. No.: 10/236,477

(22) Filed: Sep. 6, 2002

Related U.S. Application Data
(63) Continuation-in-part of application No. 10/135,180, filed on Apr. 30, 2002.
(63) Continuation-in-part of application No. 10/159,845, filed on May 31, 2002.
(63) Continuation-in-part of application No. 10/160,429, filed on May 31, 2002.
(63) Continuation-in-part of application No. 10/161,221, filed on May 31, 2002.
(63) Continuation-in-part of application No. 10/160,444, filed on May 31, 2002.
(63) Continuation-in-part of application No. 10/160,565, filed on May 31, 2002.
(63) Continuation-in-part of application No. 10/160,563, filed on May 31, 2002.
(60) Provisional application No. 60/377,027, filed on Apr. 30, 2002.
(60) Provisional application No. 60/376,625, filed on Apr. 30, 2002.
(60) Provisional application No. 60/376,655, filed on Apr. 30, 2002.
(60) Provisional application No. 60/384,717, filed on May 31, 2002.
(60) Provisional application No. 60/385,176, filed on May 31, 2002.
(60) Provisional application No. 60/384,607, filed on May 31, 2002.

(51) Int. Cl. G06F 17/00

(52) U.S. Cl. 705/2; 700/90

(57) ABSTRACT

A system and method for facilitating a time-based infusion order treatment including an infusion wizard being capable of receiving a time-based infusion order request. The system further includes a database of at least one predefined infusion order template, and a scheduler being responsive to the infusion wizard. The scheduler is capable of utilizing the time-based order request to generate an infusion treatment schedule. A publisher publishes the generated infusion treatment schedule.

### RELATED APPLICATIONS

The present application claims the benefit of the following U.S. Provisional Applications: “Medical Delivery and Information System for Use in Health Care Facilities,” Serial No. 60/377,027, filed Apr. 30, 2002; “System and Method for Integrating Structural Clinical Documentation With Point of Care Treatment of a Patient,” Serial No. 60/376,625, filed Apr. 30, 2002; “Infusion Therapy System and Method,” Serial No. 60/376,655, filed Apr. 30, 2002; “System And Method For Supporting Clinical Decisions During Patient Care And Treatment,” Serial No. 60/384,717, filed May 31, 2002; “Nursing Order Workflow System and Method,” Serial No. 60/385,176 filed May 31, 2002; “System And Method For Facilitating Orders During Patient Care And Treatment,” Serial No. 60/384,607, filed May 31, 2002; and incorporates such applications herein by reference.

This application is a continuation-in-part of the following co-pending applications: “Medical Treatment Verification System and Method,” Ser. No. 10/135,180, filed Apr. 30, 2002; “Automated Messaging Center System And Method For Use With a Healthcare System,” Ser. No. 10/159,845, filed May 31, 2002; “Infusion Therapy Bar Coding System and Method,” Ser. No. 10/160,429, filed May 31, 2002; “System and Method for Providing Multiple Units of Measurement,” Ser. No. 10/161,221, filed May 31, 2002; “Healthcare Database Management Offline Backup and Synchronization System and Method,” Ser. No. 10/160,444, filed May 31, 2002; “System And Method For Obtaining Information From A Bar Code For Use With A Healthcare System,” Ser. No. 10/160,565, filed May 31, 2002; “System And Method For Facilitating Patient Care And Treatment,” Ser. No. 10/160,563, filed May 31, 2002; and incorporates such applications herein by reference.

Additionally, the present application incorporates by reference the following applications: “Biometric Security for Access to a Storage Device for a Healthcare Facility,” Ser. No. 10/159,802 filed May 31, 2002; “Storage Device for Health Care Facility,” Ser. No. 10,160,564, filed May 31, 2002 and “Pharmacy System and Method,” Ser. No. 10,159,689 filed May 31, 2002.

The present application is being filed concurrently with and incorporates by reference the following applications: “Method and Program for Creating Healthcare Facility Order Types,” Ser. No. ______; “Method and Program for Identifying Multiple Diluent Solutions for Use in Drug Delivery With a Healthcare System,” Ser. No. ______; and “Method and Program for Providing a Maximum Concentration of a Drug Additive in a Solution,” Ser. No. ______.

### TECHNICAL FIELD

The present invention generally relates to patient care. More specifically, the present invention is directed to facilitating patient care treatment by providing healthcare personnel the ability to administer time-based infusion treatment orders.

### BACKGROUND OF THE INVENTION

Pharmaceutical and medical order entry systems may include electronic order entry of infusion treatment orders. However, these order entry systems utilize an “infusion bag” technique that is cumbersome and requires multiple calculations during preparation. Besides being impractical for physician order entry, such a method is susceptible to human error throughout the administration of the infusion treatment process. In addition, administering the infusion treatment derived from a time-based infusion order necessitates additional work for medical personnel, e.g., pharmacist and/or nurse, wherein manual calculations are required to integrate existing scheduled infusion treatments with new and/or amended infusion treatment requests.

The present invention is provided to solve these and other problems.

### SUMMARY OF THE INVENTION

The present invention is directed to a system and method for facilitating infusion orders based on time. A provider is capable of defining a duration and sequence of infusion orders. As such, additives and solutions in each infusion order may change over time without the need to define what should be included or excluded from each infusion bag. A scheduler checks the sequence and timing of all ordered solutions and identifies which solution should be used at any provider-specified time. The provider is capable of defining a period of time that a solution should run and the sequence of the solution -whether it should be repeated or stopped at a specific time interval. The present invention further allows an additive to be ordered based on time wherein the provider is allowed to designate the time that the additive should be included in the infusion. The scheduler determines which additive to include in filling an infusion bag and the sequence.

One embodiment of the present invention is a method for facilitating an infusion treatment order to be administered to a patient. The system includes a database of infusion templates and an infusion wizard for scheduling administration of the infusion treatment. The method includes receiving a time-based order for an infusion treatment. A schedule for the infusion treatment is generated based on the received time-based order. The generated schedule is published whereby medical personnel utilize the schedule to administer the infusion treatment.

Another embodiment of the present invention is a system for facilitating a time-based infusion order treatment. The system comprises an infusion wizard being capable of receiving a time-based infusion order request. A database of at least one predefined infusion order template is communicably attached to the infusion wizard. A scheduler is responsive to the infusion wizard and capable of utilizing the time-based order request to generate an infusion treatment schedule wherein a publisher provides notice of the generated infusion treatment schedule.

An object of the present invention is to facilitate ordering of an infusion treatment.

A further object of the present invention is to provide a mechanism for reducing or eliminating manual calculations for an infusion order.

Another further object of the present invention is to increase efficiency of administering an infusion treatment.

Other advantages and aspects of the present invention will become apparent from the following description of the drawings and detailed description of the invention.

### BRIEF DESCRIPTION OF THE DRAWINGS

FIG. 1 is a block diagram of one embodiment of the present invention;

FIG. 2 is a block diagram depicting the general relationships of medical personnel with infusion treatment orders and associated schedules;

FIG. 3 is a block diagram depicting the relationship between the scheduler and other system modules;

FIG. 4 is a block diagram showing logical objects involved in the creation of the IV infusion bag and the schedule;

FIG. 5 is a block diagram showing class structures of one embodiment of the scheduler and its relationship with the infusion wizard;

FIG. 6 is a block diagram of a detailed object module of one embodiment of the present invention;

FIG. 7 is a block diagram showing the activities and states involved in the creation of an infusion treatment schedule;

FIG. 8 shows an example of a schedule creation sequence; and,

FIG. 9 shows another example of a schedule creation sequence.

### DETAILED DESCRIPTION OF THE PREFERRED EMBODIMENTS

While the present invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to providing a mechanism for facilitating administration of infusion treatment orders. In prior practice, each infusion treatment order required medical personnel, e.g., pharmacist, to receive the order and make an infusion bag. Making the infusion bag required the pharmacist to analyze current infusion treatment orders and determined the amount, flow-rate, duration, time, etc., for the new order. Because of all the manual calculations and interaction required by medical personnel, preparation of the infusion bag is routinely susceptible to error. It would be beneficial for both the patient and the healthcare facility to utilize a system wherein tedious, yet important, calculations and steps can be more accurately performed. Similarly, other subsidiary improvements to such a system can further be utilized to improve the quality of provided health care, e.g., patient history records, adverse treatment interactions, etc.

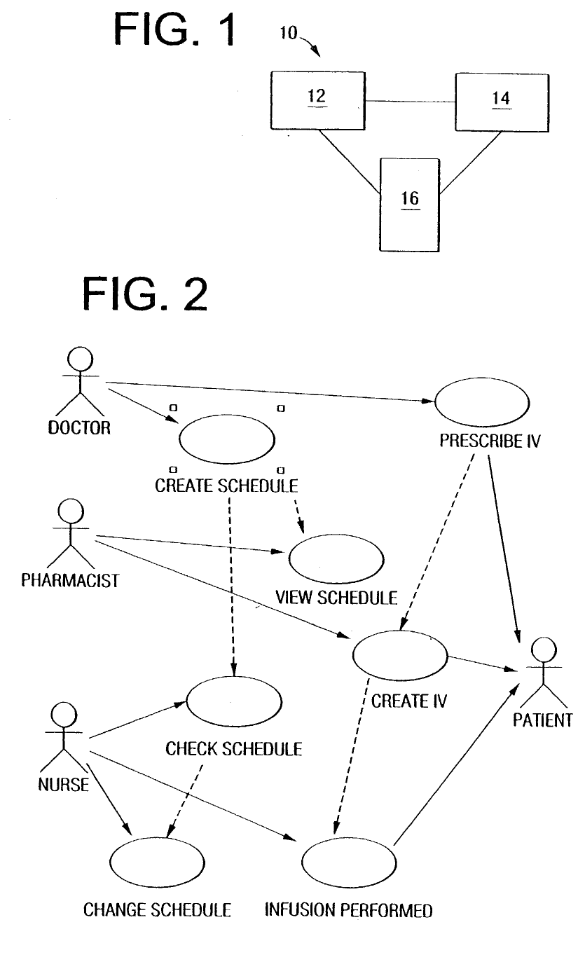

The present invention provides a healthcare facility the ability to establish a safe, accurate, and dependable ordering process for administering infusion treatments to patients. Referring to FIG. 1, a system 10 for facilitating the administration of infusion treatments includes an application or utility, i.e., infusion wizard 12, being operably connected to a database 14 for storing infusion treatment templates of various types. A scheduler 16 is operably connected to the memory 14 and the processor. The scheduler 16 is utilized with the infusion wizard 12 to create and/or alter an infusion treatment schedule capable of being used by other applications and parts of a healthcare facility. The scheduler 16 interacts with the infusion wizard 12 in response to a detailed prescription order being entered, e.g., infusion treatment order request. Provided with the detail and the requested schedule, the scheduler 16 can prepare a schedule to be published throughout the system 10. The published schedule can be approved and saved within the system 10. The “published” schedule(s) are accessible to other medical personnel, e.g., pharmacists, nurses, etc. to provide the data needed for the creation and administration of the prescribed infusion treatment. A variety of infusion treatment templates defined by the user are maintained in the database 14 and include, but are not limited to, the following infusion types: single-dose, intermittent, continuous, alternating and sequencing, tapering, and titrating. A single-dose infusion is an infusion that is only given once. Only one bag is given and no repeat bags are given.

An intermittent infusion is administered over a given time period without changes in the flow-rate—outside the defined limits of the system 10. There may be many bags given, but there is only one formulation (Rx) created. The contents of the bag are not changed during the infusion. The duration of the bag may be the same or shorter than the scheduled duration between bags. Thus, it is acceptable for the contents of the bag to be consumed before the next bag is to be started.

A continuous infusion is given over a specified period of time without interruption and without a change in flow-rate -outside the defined limits of the system. A change in flow-rate requires a modification of the order. There may be many bags provided, but there is only one formulation (Rx) created and the contents of the bag do not change during the treatment.

A tapering infusion is administered over a given period of time without interruption; however, there is a change in the flow-rate at various times. Many bags may be given, but there is only one formulation (Rx) created. There is no change in the contents of the bag from beginning to end. Similarly, an alternating infusion is given over a specified period of time without interruption, but there is a change in the flow-rate. In addition, the contents of the bag also change depending on the parameters specified at order entry.

A titrating infusion is given during a period of time without interruption. There is, however, a change in the flow-rate and bag contents depending the sequence. Many bags may be utilized, but only one formulation (Rx) is created.

FIG. 2 is a block diagram depicting the general relationships of medical personnel with infusion treatment orders and associated schedules. In general, a physician creates a prescription, e.g., infusion treatment, and associated schedule for a patient. A pharmacist views the schedule and prepares the infusion bag. The schedule may be altered by a nurse before administering to the patient.

At the Prescribe IV segment, the physician creates the prescription by selecting the appropriate drugs for the patient. A schedule is created—Create Schedule—in response to completion of the prescription. Upon completion of Prescribe IV and Create Schedule segments, View Schedule allows the schedule to be viewed by the pharmacist. Similarly, Check Schedule enables a nurse to observe the schedule associated with assigned patients. The nurse utilizes the created schedule and infusion treatment bag to administer the infusion treatment to the patient.

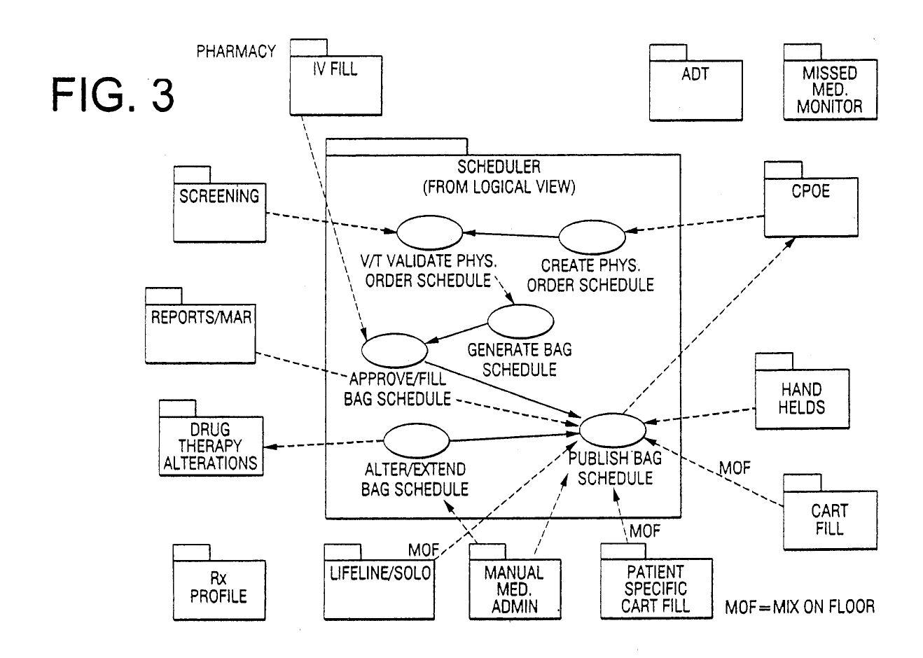

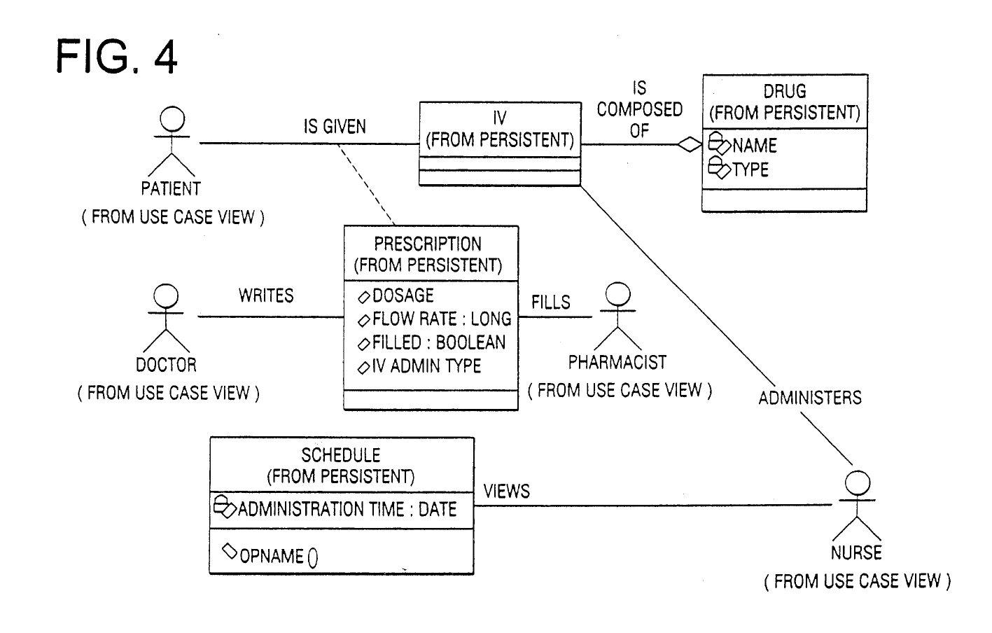

The scheduler 16 is capable of being integrated with other modules throughout a healthcare facility. An example of one embodiment incorporating a variety of external entities with the scheduler 16 is shown in FIG. 3. A physician creates an order, e.g., prescription, for a patient. The physician created order is validated to ensure that conflicts are not present. Upon validation, a schedule for an infusion treatment bag is created and approved. The approved schedule is made accessible to the external entities connected to the system 10 and throughout the healthcare facility. FIG. 4 is a block diagram depicting logical objects utilized in one embodiment of the present invention during the creation of the infusion bag and the corresponding schedule. An infusion bag is a class composed of drugs. An infusion order, e.g. prescription, is an infusion bag, or multiple bags, administered to a patient. The prescription is written by a physician and an associated schedule is created. A nurse can view the schedule and administer the infusion bag(s) to the patient.

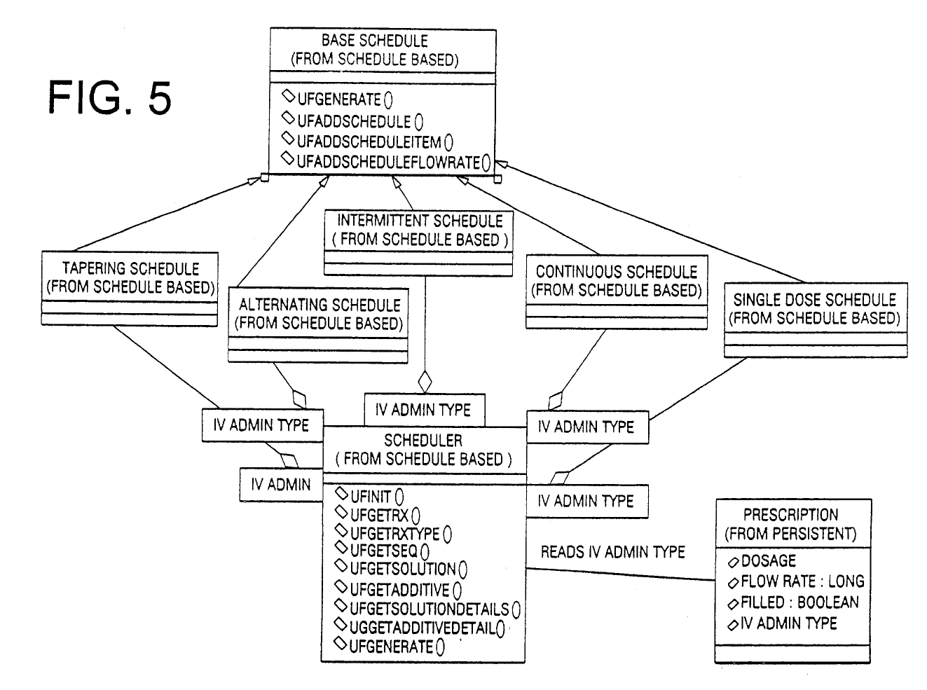

FIG. 5 depicts a detailed diagram of one embodiment for the scheduler's 16 class structure showing its class structure and its relationship with other applications utilized in the system, e.g., order entry. The base schedule is an ancestor object of the objects that are utilized by the scheduler 16 to create the physical schedule. The base object that will be used is dependent upon the type of infusion treatment being utilized.

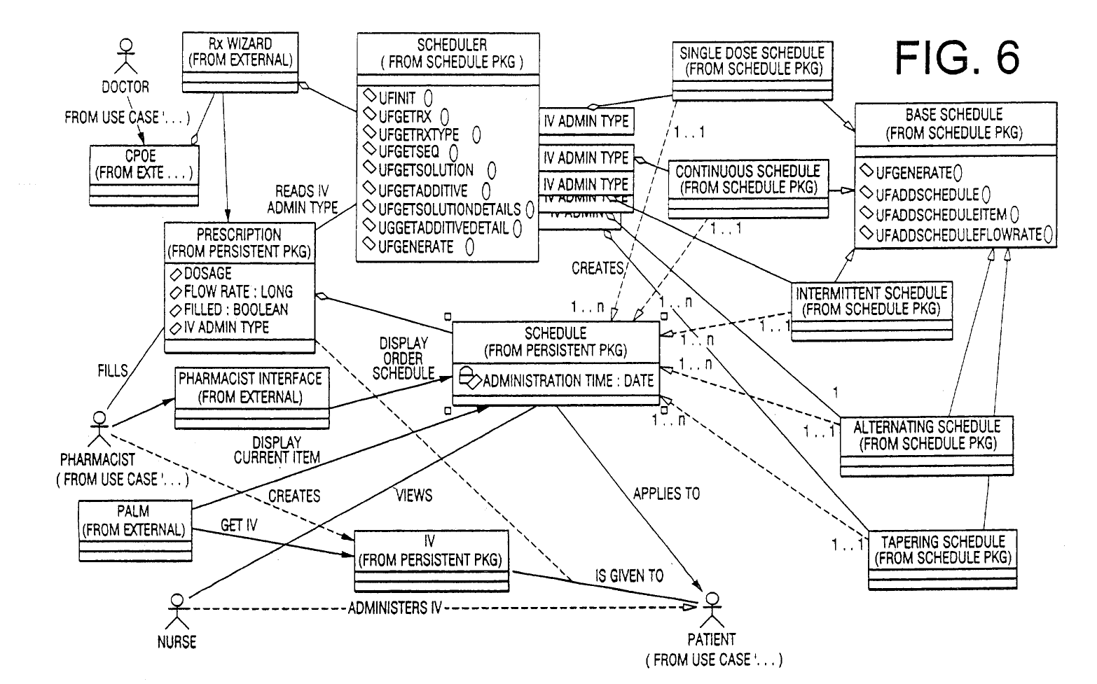

FIG. 6 depicts a detailed object model of one embodiment of the present invention. An order entry system, computerized physician order entry system (CPOE), includes an infusion wizard. The infusion wizard contains a scheduler that includes child objects of a base schedule, e.g., single-dose schedule, continuous schedule, etc. The infusion wizard utilizes the prescription that is employed by the scheduler to determine a schedule object for use in creating the infusion order treatment schedule. The schedule is accessible by medical personnel wherein a pharmacist uses the information to create the infusion bag. A nurse administers the infusion treatment to the patient in accordance with the generated schedule.

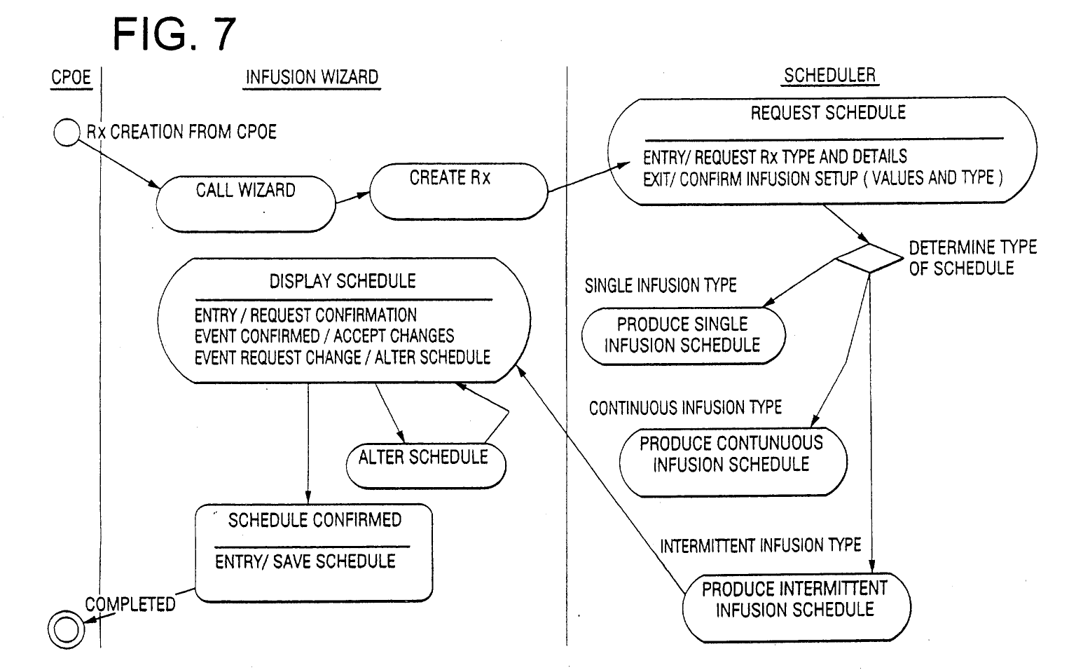

FIG. 7 shows the steps involved in the creation of a schedule in one embodiment of the present invention. An ordering system, e.g., CPOE, cooperates with a prescription creation application 14 and the scheduler 16. Medical personnel, e.g., physician, initiates a prescription order through the entry system wherein the infusion wizard 12 is opened. The infusion wizard 14 creates the prescription and requests a corresponding schedule from the scheduler 16. A schedule is created based on the type of infusion desired in the initial order. The generated schedule may require approval and can be saved and altered by designated medical personnel.

During creation of the schedule, prescription data maintained in memory can be utilized to facilitate generation of the schedule. Various base creation objects dependent on the infusion type are stored in the database 14. For example, gen-single is an object utilized to create a single infusion schedule. The gen-single object is inherited from the base object providing the generic code required to write out the data appropriate for the schedule type. The infusion generation object utilizes the formatted data of the scheduler object to create a final schedule. Within the infusion generation object, the bag duration and flow-rate can be calculated. Various memory locations associated with the gen-single object are populated and updated. It is understood that other object modules for generating schedules based on the various infusion order types can also be similarly defined, stored, and utilized within the system 10.

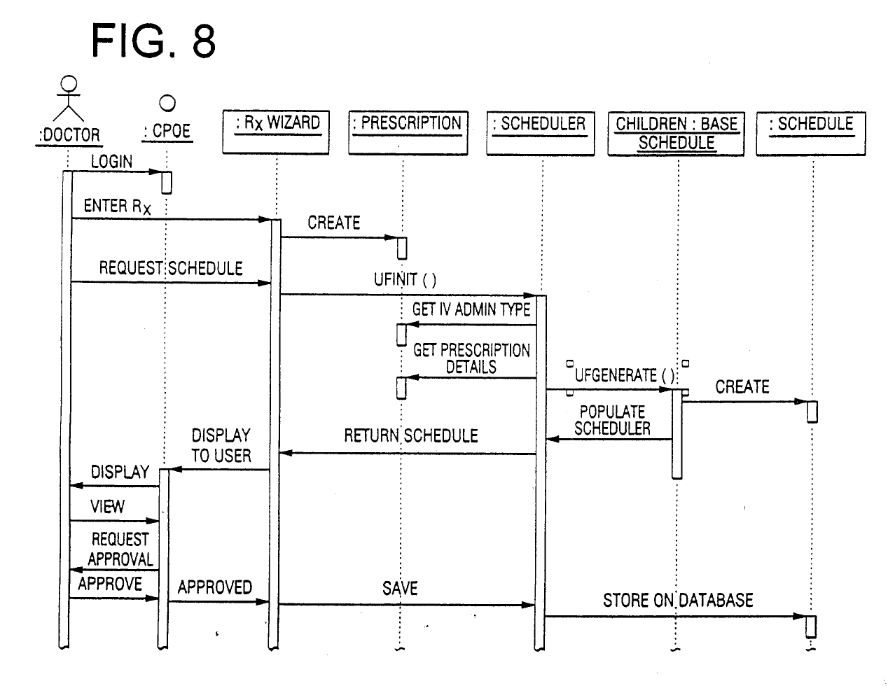

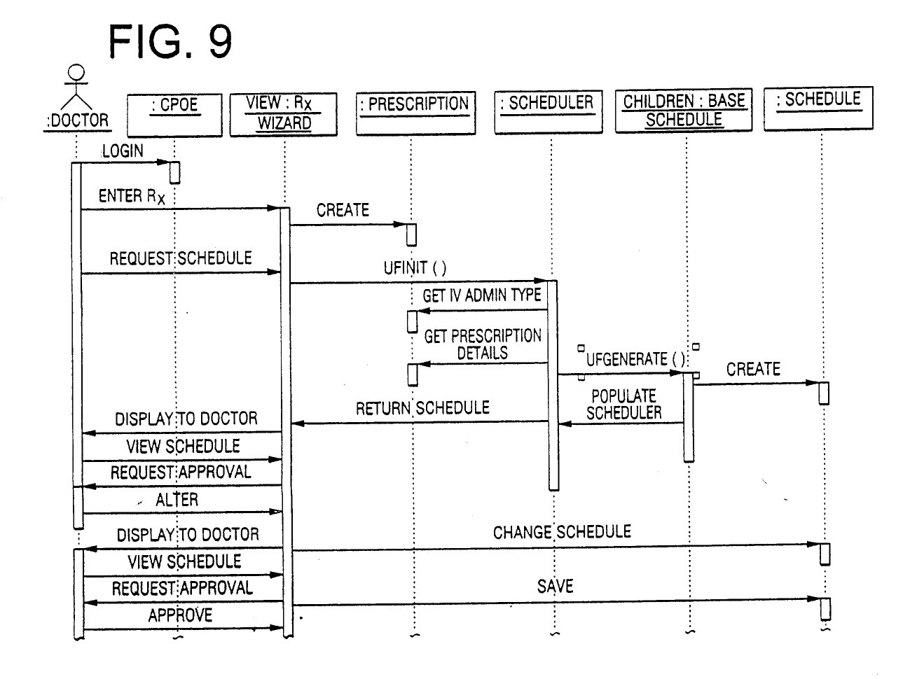

FIG. 8 provides an example of a schedule creation sequence wherein no changes to the created schedule are made. The physician logs into the order entry system and the infusion wizard 12 is utilized to enter the prescription details. The infusion wizard 12 cooperates with the scheduler 16 to generate the infusion treatment schedule. The scheduler 16 utilizes a “base” generation object—dependent upon the desired infusion type selected in the prescription—to generate the schedule. The created schedule is populated with the specifics of the prescription. The schedule is published and approval is sought from the prescription drafter, e.g., physician. Upon approval, the schedule is saved on the system 10. If approval is not attained from the physician, the schedule can be altered by authorized personnel and re-published for approval. See FIG. 9.

One embodiment of the present invention preferably will incorporate an infusion wizard 12 having the following main order types: single-dose infusion, intermittent infusion, and continuous infusion. The ability to define tapering doses and alternating and sequencing doses will be available on the wizard 12; as will the ability to define titrating doses or flow-rates according to a patient's condition. Using these main infusion order types as templates, healthcare facilities will be able to define/create many infusion order sub-types, e.g., TPN, chemo-continuous infusion, piggybacks, large volume parenterals, etc. The infusion sub-type functionality can be carried forward on any window in the application where infusions are displayed—thereby allowing the user to sort or filter infusion orders according to the healthcare-facility-defined subtypes.

When searching for a drug during order entry, it may be flagged as either an additive and/or a solution to aid a user in building an infusion order. This designation is completed in a drug file set-up procedure. Upon selection of the first ingredient in the infusion order, the infusion order wizard 12 opens and the associated infusion order sub-type for that ingredient, as designated in the ingredient's drug file, automatically defaults. It may be adjusted if necessary. The dose and its corresponding unit of measure may also default if specified in the ingredient's drug file. The drug file defaults can be enhanced to store a standard dose for each of the unit of measure options appearing in the wizard—for example, 2 mg, 2 mg/kg, 2 mg/m2, 2 mg/mg/min, 2 mg/kg/hr, etc. Furthermore, the ingredient's preferred diluent, e.g., solution, may default into the wizard 12 if defined in the ingredient's drug file. The system 10 has the ability to define one default diluent per drug in the item file. This functionality can be improved to allow for multiple default diluents to be specified in each drug file with one being designated as the preferred. A note may be associated with the diluent to assist the user in deciding which diluent to select. Such a note may include, for example, a reference avoiding use of a particular diluent if a patient is hypertonic.

While creating the infusion order, an infusion wizard calculator can be utilized to determine the flow-rate (if not specified), the number of solutions/bags required for a specified period of time, the concentration of the primary ingredient in each solution, the time period over which each solution/bag is to be administered, and the total volume of each solution/bag. Flow-rates may be manually entered or adjusted by altering the final concentration or the duration of each solution or bag. Based on the calculations, the maximum concentration of the solution should never be exceeded. However, if at anytime while a user is adjusting the flow-rate by adjusting the final concentration resulting in the final concentration of each solution exceeding the maximum concentration of the primary ingredient as identified in the ingredient's drug file, the system 10 will alert the user and may ask for an override reason if placement of the order is still desired.

As provided by the present invention, it is no longer necessary to define an end-date for an order. A continuous schedule generator will be created, which will automatically look ahead a pre-defined time period and generate a schedule for admixture filling for that time period—or longer, if desired. This feature improves the performance during order entry and filling procedures. For example, an order can be placed for 0.45% NaCl, 1000 ml, at 100 ml/hr, add MVI every morning and Thiamine every evening on Monday and Wednesday. The system of the present invention will identify which infusion bag will be administered in the morning or evening to determine which additives should be added to any given infusion bag.

It will be understood that the invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. A method for facilitating an infusion treatment order to be administered to a patient, the system includes a database of infusion templates and an application for scheduling administration of the infusion treatment, the method comprising the steps of:
receiving a time-based order for an infusion treatment;
generating a schedule for the infusion treatment, the schedule being responsive to the received time-based order for the infusion treatment; and,
publishing the generated schedule for the infusion treatment.

2. The method of claim 1 further comprising:
utilizing the generated schedule to create an infusion bag.

3. The method of claim 1 further comprising:
administering the infusion treatment to the patient.

4. The method of claim 1 further comprising:
altering the generated schedule.

5. The method of claim 1 further comprising:
validating the received order for an infusion treatment.

6. The method of claim 5 further comprising:
executing an alert in response to the validation of the received order for an infusion treatment.

7. The method of claim 1 wherein generating a schedule for an infusion treatment comprises the steps of:
determining an infusion treatment type in response to the received time-based order for an infusion treatment;
selecting an infusion treatment template from the infusion treatment database in response to the determined infusion treatment type; and,
populating the selected infusion treatment template with data corresponding to the request for a time-based infusion treatment.

8. The method of claim 1 further comprising the step of:
identifying a schedule parameter generated in response to the time-based order as being system-generated.

9. The method of claim 1 wherein the time-based order for an infusion treatment includes a flow-rate.

10. The method of claim 1 wherein the time-based order for an infusion treatment includes an infusion bag duration.

11. A system for facilitating a time-based infusion order treatment, the system comprising:
an infusion wizard being capable of receiving a time-based infusion order request;
a database of at least one predefined infusion order template;
a scheduler being responsive to the infusion wizard, the scheduler being capable of utilizing the time-based order request to generate an infusion treatment schedule; and,
a publisher for publishing the generated infusion treatment schedule.

12. The system of claim 1 further comprising:
an infusion bag created in response to the generated schedule.

13. The system of claim 1 further comprising:
an altering module for modifying the generated schedule.

14. The system of claim 1 further comprising:
a validator for validating the received order for a time-based infusion order treatment.

15. The system of claim 1 further comprising:
an alarm being responsive to the validator.

16. A computer readable medium having a computer program for a system to facilitate an infusion treatment order, the system includes a database of infusion templates and an application for scheduling administration of the infusion treatment, the medium comprising:
a first segment for receiving a time-based order for an infusion treatment;
a second segment for generating a schedule for the infusion treatment, the schedule being responsive to the received time-based order for the infusion treatment; and,
a third segment for publishing the generated schedule for the infusion treatment.

17. The computer readable medium of claim 16 further comprising:
a fourth segment for utilizing the generated schedule to create an infusion bag.

18. The computer readable medium of claim 16 further comprising:
a fifth segment for administering the infusion treatment to the patient.

19. The computer readable medium of claim 16 further comprising:
a sixth segment for altering the generated schedule.

20. The computer readable medium of claim 16 further comprising:
a seventh segment for validating the received order for an infusion treatment.

21. The computer readable medium of claim 20 further comprising:
an eighth segment for executing an alert in response to the validation of the received order for an infusion treatment.

22. The computer readable medium of claim 16 wherein the second segment for generating a schedule for an infusion treatment comprises:
a ninth segment for determining an infusion treatment type in response to the received order for an infusion treatment;
a tenth segment for selecting an infusion treatment template from the infusion treatment database in response to the determined infusion treatment type; and,
an eleventh segment for populating the selected infusion treatment template with data corresponding to the request for a time-based infusion treatment.

23. The computer readable medium of claim 16 further comprising:
a twelfth segment for identifying a schedule parameter generated in response to the time-based order as being system-generated.
